(19) United States
(12) Patent Application Publication
(10) Pub. No.: US 2025/0158250 A1
(43) Pub. Date: May 15, 2025

(54) SECONDARY BATTERY

(71) Applicant: Samsung SDI Co., Ltd., Yongin-si (KR)

(72) Inventors: Ho Lim PARK, Yongin-si (KR); Hwan Jun CHOI, Yongin-si (KR); Seo Young KIM, Yongin-si (KR)

(21) Appl. No.: 18/632,165

(22) Filed: Apr. 10, 2024

(30) Foreign Application Priority Data
Nov. 15, 2023 (KR) 10-2023-0158393

(51) Int. Cl. H01M 50/548; H01M 50/103; H01M 50/15; H01M 50/176; H01M 50/566

(52) U.S. Cl. CPC H01M 50/548; H01M 50/103; H01M 50/15; H01M 50/176; H01M 50/566

(57) ABSTRACT

A secondary battery includes: a prismatic case having at least one end open; an electrode assembly accommodated in the case; a pair of current collection plates at both ends of the electrode assembly in the longitudinal direction and electrically connected to the electrode assembly; and a pair of cap assemblies each coupled to both open ends of the case and having terminal portions electrically connected to the current collection plate, wherein each of the terminal portions may include a terminal post that protrudes toward the current collection plate and is electrically connected to the current collection plate.

### CROSS-REFERENCE TO RELATED APPLICATION

The present application claims priority to and the benefit of Korean Patent Application No. 10-2023-0158393, filed on Nov. 15, 2023, in the Korean Intellectual Property Office, the entire disclosure of which is incorporated herein by reference.

### BACKGROUND

### 1. Field

Aspects of some embodiments of the present disclosure relate to a secondary battery having a relatively improved cap assembly structure.

### 2. Description of the Related Art

In recent years, various attempts and improvements have been made to increase the capacity or improve the performance of secondary batteries. A general prismatic secondary battery for a battery module used in an electric vehicle, etc. may be constructed such that a positive electrode terminal and a negative electrode terminal are provided at the top of a rectangular parallelepiped shape. However, such a top terminal type secondary battery may have a relatively complex internal structure to construct the positive and negative terminals at the top. To solve this problem, a secondary battery may be utilized in which a negative electrode terminal is placed at one end of the longitudinal direction and a positive electrode terminal is placed at the other end. This type of secondary battery may be referred to as a side terminal type secondary battery.

The side terminal type secondary battery may have a relatively simpler terminal structure than a top terminal type secondary battery. Therefore, side terminal type secondary batteries may be superior in terms of energy density due to high utilization of internal space. Aspects of some embodiments may further improve a side terminal type secondary battery, improve the coupling between a terminal and a current collector, and reduce welding defects.

The above information disclosed in this Background section is only for enhancement of understanding of the background and therefore the information discussed in this Background section does not necessarily constitute prior art.

### SUMMARY

Aspects of some embodiments of the present disclosure include a secondary battery having a relatively improved cap assembly structure.

These and other aspects and features of some embodiments according to the present disclosure will be described in or will be apparent from the following description of the following disclosed embodiments of the present disclosure.

A secondary battery according to some embodiments of the present disclosure may include: a prismatic case having at least one end open; an electrode assembly accommodated in the case; a pair of current collection plates at both ends of the electrode assembly in the longitudinal direction and electrically connected to the electrode assembly; and a pair of cap assemblies each coupled to both open ends of the case and having terminal portions electrically connected to the current collection plate, wherein each of the terminal portions may include a terminal post that protrudes toward the current collection plate and is electrically connected to the current collection plate.

According to some embodiments, the cap assembly may include a cap plate coupled to the case, an insulator made of an insulating material outside the cap plate, and the terminal portion.

According to some embodiments, the terminal portion may include the current collection plate between the cap plate and the current collection plate, a sub-terminal outside the insulator and electrically connected to the current collection plate, and a terminal plate outside the sub-terminal and electrically connected to the sub-terminal.

According to some embodiments, the sub-terminal and the terminal plate may be separately provided.

According to some embodiments, the sub-terminal and the terminal plate may be integrally provided.

According to some embodiments, the terminal post may be provided in the sub-terminal.

According to some embodiments, a hole into which the terminal post is inserted may be provided to penetrate in the cap plate and the insulator.

According to some embodiments, in the current collection plate, a plate surface facing the cap plate may be a flat surface.

According to some embodiments, the current collection plate may include a flat groove concavely provided on the plate surface facing the cap plate.

According to some embodiments, the flat groove may be circular or polygonal.

According to some embodiments, the terminal post may have a circular or polygonal cross-section and may be shaped of a hollow cylinder.

According to some embodiments, the diameter of the flat groove may be larger than the diameter of the terminal.

According to some embodiments, the diameter of the hole in the cap plate and the insulator may be larger than the diameter of the terminal post.

According to some embodiments, a welding hole communicating with the terminal post may be provided to penetrate.

According to some embodiments, the secondary battery may include a pair of current collection plates between the electrode assembly and the current collection plate and electrically connected to the electrode assembly and the current collection plate.

According to some embodiments, the current collection plate may include a first plate surface protruding toward the cap plate, a connecting surface extending from both ends of the first plate surface, and a second plate surface extending from the connecting surface and welded to an electrode substrate tab of the electrode assembly.

According to some embodiments, the insulator may include a first coupling portion outside the cap plate and a second coupling portion inside the cap plate toward the current collection plate.

According to some embodiments, a groove in which the sub-terminal and the terminal are seated may be concavely provided the first coupling portion, and a groove in which the current collection plate is seated may be concavely provided in the second coupling portion.

According to some embodiments, the height of the groove in the second coupling portion may be smaller than the height of the current collection plate.

According to some embodiments, the height of the groove in the first coupling portion may be smaller than the sum of the heights of the sub-terminal and the terminal plate.

According to some embodiments, the terminal plate is a rectangular plate, which has a step between the outer surface and the surface facing the sub-terminal.

According to some embodiments, the terminal plate may have a flange having an edge of the surface facing the sub-terminal protruding outward.

According to some embodiments, in the terminal plate, the size of the surface facing the sub-terminal may correspond to the size of the sub-terminal.

According to some embodiments, the insulator may further include an insertion groove provided concavely inside the groove of the first coupling portion, so that the flange of the terminal plate and the sub-terminal are inserted.

According to some embodiments, the terminal post and the current collection plate may be welded to each other through the welding hole of the terminal.

### BRIEF DESCRIPTION OF DRAWINGS

FIG. 1 is a perspective view of a secondary battery according to some embodiments of the present disclosure.

FIGS. 2A and 2B are partially exploded perspective views of secondary batteries according to some embodiments of the present disclosure.

FIG. 3 is a partial cross-sectional view of the secondary battery according to FIG. 1 according to some embodiments of the present disclosure.

FIG. 4 is a partial cross-sectional view showing some steps in the manufacturing process of the secondary battery according to FIG. 1 according to some embodiments of the present disclosure.

FIG. 5 is a partial cross-sectional view showing a terminal welding step in the manufacturing process of the secondary battery according to FIG. 1 according to some embodiments of the present disclosure.

### DETAILED DESCRIPTION

Aspects of some embodiments of the present disclosure are provided to more fully describe embodiments according to the present disclosure to those skilled in the art, and the following embodiments may be embodied in many different forms and should not be construed as being limited to the example embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components are exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A can be directly connected to the element B or an intervening element C may be present therebetween such that the element A and the element B are indirectly connected to each other.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the term “below” can encompass both an orientation of above and below.

Hereinafter, a secondary battery according to some embodiments of the present disclosure will be described in more detail with reference to the attached drawings.

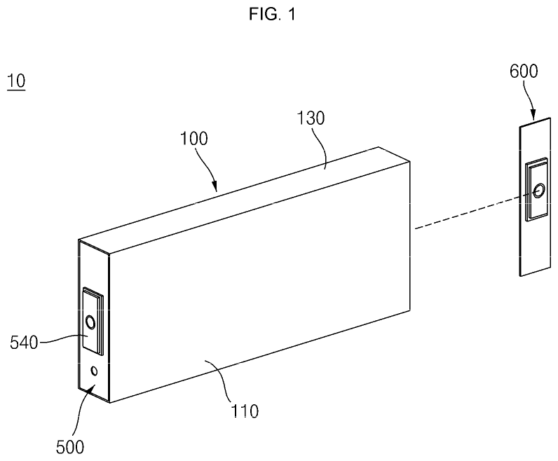

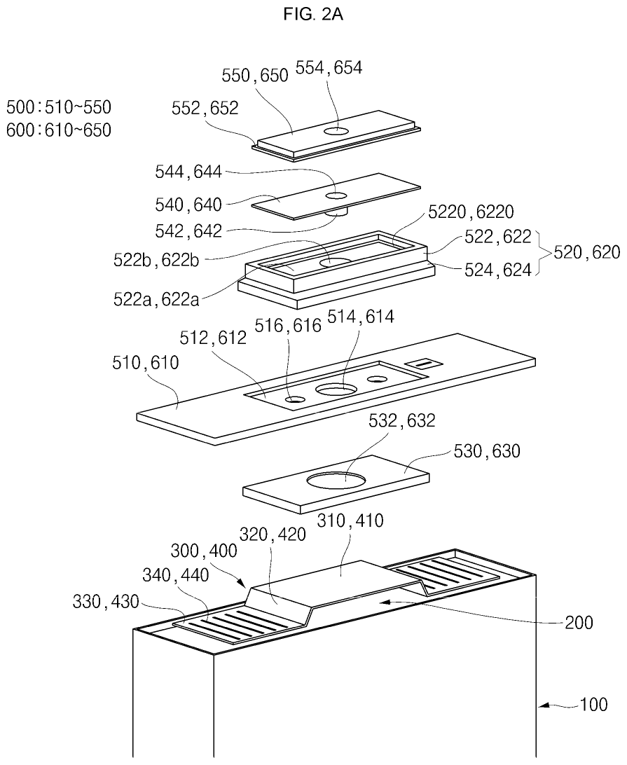

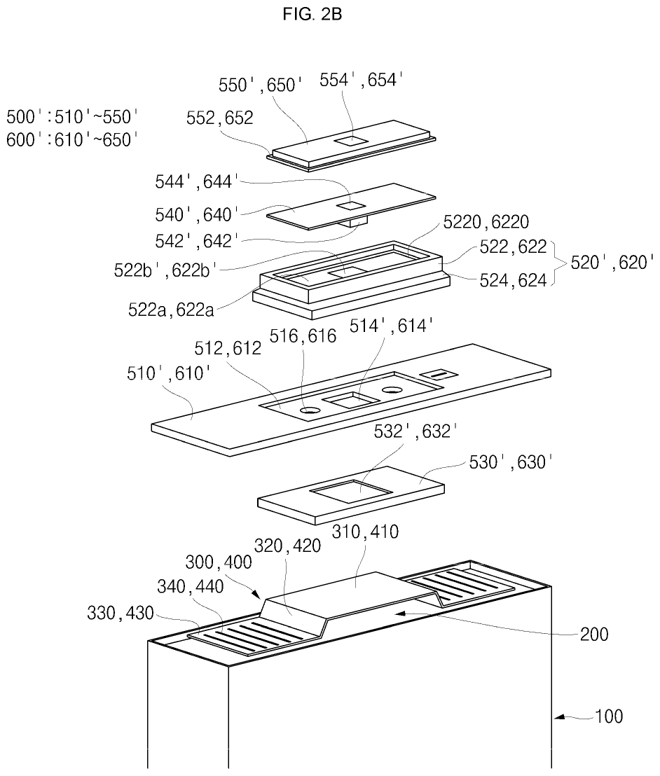

FIG. 1 is a perspective view of a secondary battery according to some embodiments of the present disclosure. FIGS. 2A and 2B are partially exploded perspective views of secondary batteries according to some embodiments of the present disclosure. FIG. 3 is a partial cross-sectional view of the secondary battery according to FIG. 1.

Referring to FIGS. 1 to 3, the secondary battery 10 according to some embodiments of the present disclosure may include a case 100, an electrode assembly 200 accommodated inside the case 100, a first current collection plate 300, and a second current collection plate 400, and a first cap assembly 500 and a second cap assembly 600 coupled to the case 100.

The case 100 is shaped of a rectangular parallelepiped and has both ends open in the longitudinal direction. Except for the open ends of the case 100, the case 100 includes a first side 110 and a second side, which are relatively widest plate surfaces, and a third side 130 and a fourth side, which connect the first side 110 and the second side. The first side 110 and the second side have relatively large areas compared to the third side 130 and the fourth side. Therefore, the first side 110 and the second side may be defined as long side portions. The third side 130 and the fourth side may be defined as short side portions. According to some embodiments, a vent for gas discharge may be provided on the third side 130 or the fourth side when the internal pressure increases.

The case 100 may be made of steel, a steel alloy, aluminum, an aluminum alloy, or equivalents thereof, but the material is not limited thereto. The electrode assembly 200 is accommodated inside the case 100 together with an electrolyte. The first cap assembly 500 and the second cap assembly 600 may be located at both open ends of the case 100, respectively.

The electrode assembly 200 is shaped of a rectangular parallelepiped corresponding to the case 100. The electrode assembly 200 may be configured such that a first electrode plate, a second electrode plate, and a separator interposed therebetween are wound or laminated. According to some embodiments, the first electrode plate may be a positive electrode plate, and the second electrode plate may be a negative electrode plate. However, the opposite may also be possible.

In the first electrode plate, a positive active material layer may be formed on at least one surface of an aluminum (Al) foil by coating, etc. As an example, the positive electrode active material layer may be a transition metal oxide (LiCoO2, LiNiO2, LiMn2O4, etc.). The first electrode plate may be provided with a first electrode uncoated portion in which the positive electrode active material layer is not formed. A plurality of first electrode substrate tabs may be formed by cutting the uncoated portion of the first electrode into a certain shape by notching, etc. The first electrode substrate tab may be arranged toward one end of the electrode assembly 200. As an example, the first electrode substrate tab may be divided and located on both sides of the end of the electrode assembly 200 except for the center. The first electrode substrate tab may be electrically connected to the first current collection plate 300.

In the second electrode plate, a negative electrode active material layer may be formed by coating, etc. on at least one surface of a copper (Cu) or nickel (Ni) foil. As an example, the negative electrode active material layer may be graphite, carbon, etc. The second electrode plate may be provided with a second electrode uncoated portion in which a negative electrode active material layer is not formed. A plurality of second electrode substrate tabs may be formed by cutting the uncoated portion of the second electrode into a certain shape by notching, etc. The second electrode substrate tab may be arranged toward the other end of the electrode assembly 200. As an example, the second electrode substrate tab may be divided and located on both sides of the end of the electrode assembly 200 except for the center. The second electrode substrate tab may be electrically connected to the second current collection plate 400.

The separator may be polyethylene (PE) or polypropylene (PP), but embodiments according to the present disclosure are not limited thereto. The separator can prevent an electrical short between the first electrode plate and the second electrode plate and only enable the movement of lithium ions.

Referring to FIGS. 2A, 2B, and 3, the first current collection plate 300 is made of the same material as the first electrode substrate tab and may have a plate shape. As an example, the first current collection plate 300 may be in the shape made by folding a rectangular plate several times. For example, the first current collection plate 300 may include a first plate surface 310 that protrudes toward cap plates 510 and 610, which will be described in more detail later, connecting surfaces 320 extending from both ends of the first plate surface 310, respectively, and a second plate surface 330 in contact with the first electrode substrate tab. A welding portion 340 may be provided on the second plate surface 330.

The first plate surface 310 has a rectangular shape and is arranged to face the cap plates 510 and 610, which will be described in more detail later. The connecting surfaces 320 extend from both ends in the longitudinal direction of the first plate surface 310, respectively. The connecting surfaces 320 extend obliquely downward from the first plate surface 310. The connecting surfaces 320 may be made by folding the first plate surface 310 at a right angle or an angle greater than the right angle. The upper ends of the connecting surfaces 320 are connected to the first plate surface 310, and the lower ends of the connecting surfaces 320 are connected to the second plate surface 330. The second plate surface 330 may be made by folding the connecting surfaces 320 at a right angle or an angle greater than the right angle. In addition, the second plate surface 330 may be parallel to the first plate surface 310. The second plate surface 330 may be welded by, for example, ultrasonic or laser welding, in a state of being in close contact with the first electrode substrate tab. Accordingly, the welding portion 340 (or welding line) is formed to have a preset shape on the second plate surface 330. As a result, the first current collection plate 300 and the first electrode substrate tab may be electrically connected. According to some embodiments, the first electrode plate is a positive electrode, and thus the first current collection plate 300 may have a positive polarity.

The second current collection plate 400 may have the same shape as the first current collection plate 300. The second current collection plate 400 is located at the end of the electrode assembly 200 opposite to the first current collection plate 300. The second current collection plate 400 may be electrically connected to the second electrode substrate tab using the same structure and method as the first current collection plate 300. According to some embodiments, the second electrode plate is a negative electrode, the second current collection plate 400 may have a negative polarity. The first current collection plate 300 and the second current collection plate 400 may be electrically connected to the cap assemblies 500 and 600.

Referring to FIGS. 2A and 3, the cap assemblies 500 and 600 are provided as a pair, and the first cap assembly 500 connected to the first current collection plate 300 may have the same structure as the second cap assembly 600 connected to the second current collection plate 400. Hereinafter, the common structure of the first cap assembly 500 and the second cap assembly 600 will be described.

The cap assembly 500, 600 may include a cap plate 510, 610, an insulator 520, 620 located outside the cap plate 510, 610, a current collection plate 530, 630 located inside the cap plate 510, 610 (toward the electrode assembly), and a sub-terminal 540, 640 and a terminal plate 550, 650, located outside the insulator 520, 620. The current collection plate 530, 630, the sub-terminal 540, 640, and the terminal plate 550, 650 are electrically connected to each other, and thus are referred to as a terminal portion.

The cap plate 510, 610 has a rectangular plate shape and is shaped to corresponding to the open ends of the case 100. The cap plate 510, 610 may be made of the same or similar material as the case 100. A receiving groove 512, 612 in which the insulator 520, 620 is seated may be concavely provided on the outer surface of the cap plate 510, 610. Accordingly, the thickness of the receiving groove 512, 612 is smaller than the thickness of the other part of the cap plate 510, 610. As an example, the receiving groove 512, 612 may be rectangular. One terminal hole 514, 614 and a pair of fixing holes 516, 616 may penetrate the area where the receiving groove 512, 612 is provided.

The terminal hole 514, 614 is a circular hole and is located in the center of the cap plate 510, 610. The terminal plate 550, 650, which will be described later, may be connected to the current collection plate 530, 630 through the terminal hole 514, 614.

The fixing hole 516, 616 is a circular hole, and the cap plate 510, 610 is arranged to be spaced apart from the terminal hole 514, 614 along the longitudinal direction. The fixing hole 516, 616 may be placed on both sides of the terminal hole 514, 614, respectively. The fixing hole 516, 616 is a hole through which the material of the insulator 520, 620 is double-injected with the cap plate 510, 610, which will be described later. The material of the insulator 520, 620 enters the fixing hole 516, 616 and hardens, and thus the insulator 520, 620 may be integrally provided with and fixed to the cap plate 510, 610.

The insulator 520, 620 is an insulator that insulates the cap plate 510, 610 from the current collection plate 530, 630, the sub-terminal 540, 640, and the terminal plate 550, 650. In FIG. 2, the insulator 520, 620 is shown as a separate element. However, in the manufacturing process, the insulator 520, 620 may be formed integrally with the cap plate 510, 610, as shown in FIG. 3, by, for example, double injection. The insulator 520, 620 may include a first coupling portion 522, 622 located outside the cap plate 510, 610, and a second coupling portion 524, 624 located inside the cap plate 510, 610. Here, the inside of the cap plate 510, 610 refers to the inside of the case 100, on the basis of a state in which the cap plate 510, 610 is coupled to the case 100. The first coupling portion 522, 622 and the second coupling portion 524, 624 may have a substantially rectangular parallelepiped shape.

In the first coupling portion 522, 622, a groove 522a, 622a in which the sub-terminal 540, 640 and the terminal plate 550, 650 are seated is concavely provided. The groove 522a, 622a may be shaped to correspond to the sub-terminal 540, 640 and the terminal plate 550, 650. The height of the first coupling portion 522, 622 may be less than the sum of the heights of the sub-terminal 540, 640 and the terminal plate 550, 650. Therefore, in a state in which the sub-terminal 540, 640 and the terminal plate 550, 650 are seated on the first coupling portion 522, 622, the terminal plate 550, 650 may protrude outward than the first coupling portion 522, 622. Referring to FIG. 3, an insertion groove 5220, 6220 sized and shaped to correspond to the sub-terminal 540, 640 and the terminal plate 550, 650, which will be described later, may be provided inside the groove 522a, 622a.

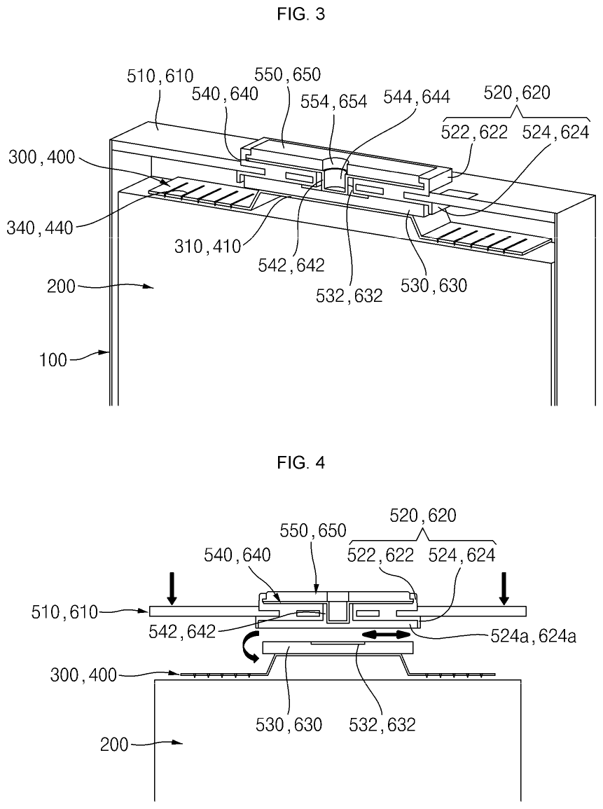

The insertion groove 5220, 6220 may prevent the sub-terminal 540, 640 and the terminal plate 550, 650 from being separated. As an example, the groove 522a, 622a may be substantially rectangular in shape, and the insertion groove 5220, 6220 may be concavely provided along the inner edge. The edges of the sub-terminal 540, 640 and the terminal plate 550, 650 may be inserted into the insertion groove 5220, 6220 (see FIGS. 3 and 4). In addition, a through hole 522b, 622b penetrating from the outside to the inside is provided in the center of the groove 522a, 622a. The through hole 522b, 622b communicates from the outside to the inside of the insulator 520, 620, and is connected to the terminal hole 514, 614.

In the second coupling portion 524, 624, a groove 524a, 624a (see FIGS. 3 and 4) in which the current collection plate 530, 630 is seated is concavely provided. The groove 524a, 624a may be shaped to correspond to the current collection plate 530, 630. On the basis of the longitudinal direction of the insulator 520, 620, the length of the groove 524a, 624a may be greater than or equal to the length of the current collection plate 530, 630. In addition, on the basis of the thickness direction of the insulator 520, 620, the thickness of the second coupling portion 524, 624 is smaller than the thickness of the current collection plate 530, 630. Therefore, when the current collection plate 530, 630 is seated on the second coupling portion 524, 624, the current collection plate 530, 630 protrudes more than the second coupling portion 524, 624 in the direction of the current collection plate 300, 400.

The current collection plate 530, 630 is shaped of a rectangular plate in which both sides facing the current collection plate and the cap plate 510, 610 are both flat. The current collection plate 530, 630 is located inside the cap plate 510, 610. The size of the current collection plate 530, 630 may be greater than or equal to that of the first plate surface 310, 410 of the current collection plate 530, 630. One side of the current collection plate 530, 630 is welded to the current collection plate, and for this purpose, the current collection plate 530, 630 may be made of the same material as the current collection plate. Alternatively, at least the surface of the current collection plate 530, 630 in contact with the first plate surface 310 may be coated with the same material as the current collection plate 530, 630.

The current collection plate 530, 630 electrically connected to the first current collection plate 300 may be made of aluminum or may include an aluminum coated layer. The current collection plate 530, 630, which is electrically connected to the second current collection plate 400, may be made of copper or nickel or may include a copper or nickel coated layer. On the other surface of the current collection plate 530, 630, a flat groove 532, 632 for connection to the sub-terminal 540, 640 may be concavely provided. As an example, the flat groove 532, 632 may be circular. In addition, the size of the flat groove 532, 632 may be larger than that of the terminal post 542, 642 of the sub-terminal 540, 640, which will be described later. When the flat groove 532, 632 is formed to have a circular shape, the diameter of the flat groove 532, 632 may be larger than the diameter of the terminal post 542, 642. As an example, the diameter of the flat groove 532, 632 may be more than twice the diameter of the terminal post 542, 642.

The sub-terminal 540, 640 is located outside the insulator 520, 620 and is electrically connected to the current collection plate 530, 630. The sub-terminal 540, 640 has a rectangular plate shape and includes the terminal post 542, 642 protruding from one side. The terminal post 542, 642 is shaped of a cylinder having an empty interior. Accordingly, a circular hole 544, 644 corresponding to the cross-sectional shape of the terminal post 542, 642 may be provided on the upper surface of the sub-terminal 540, 640. The terminal post 542, 642 extends from the plate surface facing the insulator of the sub-terminal 540, 640. The terminal post 542, 642 is located in the center of the sub-terminal 540, 640 and is inserted into the through hole 522b, 622b of the insulator 520, 620. The terminal post 542, 642 may protrude past the first coupling portion 522, 622 to the second coupling portion 524, 624. The terminal post 542, 642 needs to protrude more than the inner surface of the cap plate 510, 610 at least through the through hole 522b, 622b of the insulator 520, 620. Accordingly, when the cap plate 510, 610 is coupled to the case 100, the ends of the terminal post 542, 642 come into contact with the flat groove 532, 632 of the current collection plate 530, 630. The terminal post 542, 642 is electrically connected to the current collection plate 530, 630 by welding. Therefore, the sub-terminal 540, 640 may be made of the same material as the current collection plate 530, 630. Alternatively, at least the terminal post 542, 642 may be made of the same material as the current collection plate 530, 630. Alternatively, the surface where the current collection plate 530, 630 is connected to the terminal post 542, 642 may include a coating layer made of the same material as the sub-terminal 540, 640. The terminal plate 550, 650 is located outside the sub-terminal 540, 640.

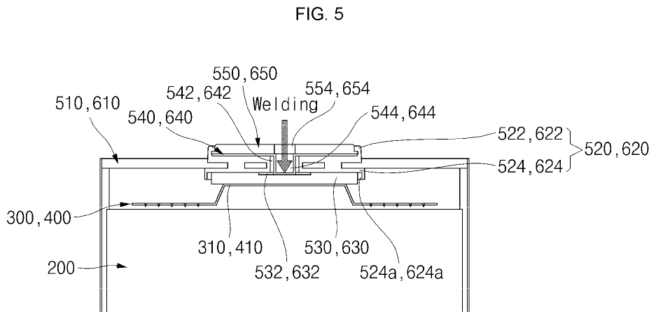

The terminal plate 550, 650 is a rectangular plate and may be made of the same or similar material as the sub-terminal 540, 640. The terminal plate 550, 650 may be made of any material that can be electrically connected to the sub-terminal 540, 640. The surface where the terminal plate 550, 650 is connected to a bus bar is defined as the outer surface, and the surface facing the sub-terminal 540, 640 is defined as the inner surface. The inner surface of the terminal plate 550, 650 may be larger than the outer surface thereof. Therefore, there may be a step between the outer and inner surfaces of the terminal plate 550, 650. Because the inner surface of the terminal plate 550, 650 is larger than the outer surface thereof, the edges thereof may protrude than the outer surface. The protruding portion is referred to as a flange 552, 652. The size of the inner surface having the flange 552, 652 may be the same as the sub-terminal 540, 640. In addition, a welding hole 554, 654 communicating with the terminal post 542, 642 penetrate the center of the terminal plate 550, 650. During the manufacturing process of the secondary battery 10, the terminal post 542, 642 and the current collection plate 530, 630 may be welded through the welding hole 554, 654 (see FIG. 5). Alternatively, when the terminal post 542, 642 and the current collection plate 530, 630 are welded, the first plate surface 310, 410 of the current collection plate may also be welded.

In the foregoing embodiments, an example in which the sub-terminal 540, 640 and the terminal plate 550, 650 are separately provided, has been described. However, the sub-terminal 540, 640 and the terminal plate 550, 650 may also be integrally provided.

As described above, a through hole 522b, 622b, a terminal hole 514, 614, a flat groove 532, 632, and a welding hole 554, 654 are provided to be shaped to correspond to the terminal post 542, 642, and thus the adhesion of terminal components can be relatively improved. In addition, because the terminal plate 550, 650 can be welded at once through the welding hole 554, 654, the insertion of a welding device can be facilitated and weldability can be relatively improved.

Meanwhile, the shapes of some components of the above-described cap assemblies 500 and 600 may be different from those shown in FIG. 2A (hereinafter, some repetitive descriptions of the same structures and features as those of the above-described embodiments may be omitted).

Referring to FIG. 2B, a terminal post 542′, 642′ of a sub-terminal 540′, 640′ may not be cylindrical but may be in the form of a column having a square cross-section (cube shape). Corresponding to the shape of the terminal post 542′, 642′, a hole 544′, 644′ provided on the upper surface of the sub-terminal 540′, 640′ may also be provided to have a square shape.

In addition, corresponding to the shape of the terminal post 542′, 642′, a through hole 522b′, 622b′ of an insulator 520′, 620′, a terminal hole 514′ of a cap plate 510′, 610′, and a flat groove 532′, 632′ of a current collection plate 530′, 630′ may also be provided to have a square shape. In addition, corresponding to the shape of the hole 544′, 644′ on the upper surface of the sub-terminal 540′, 640′, a welding hole 554′, 654′ of a terminal plate 550′, 650′ may also be provided to have a square shape.

Alternatively, according to some embodiments, the terminal post may be provided in a shape other than the shape described above.

The above-described terminal post and the corresponding hole and groove are designed to relatively improve adhesion of the terminal structure and facilitate insertion. That is, the shape of the hole through which the terminal post passes or the shape of the groove into which the terminal post is seated is provided corresponding to the shape of the terminal post corresponding to the protrusion. Therefore, as long as the terminal post and the shape of the hole or groove corresponding to the shape are provided, the shape can be applied without limitation.

Hereinafter, some processes for manufacturing the secondary battery having the above-described structure will be described in more detail (for convenience, the description will be based on the structure of FIG. 2A).

FIG. 4 is a partial cross-sectional view showing some steps in the manufacturing process of the secondary battery according to FIG. 1. FIG. 5 is a partial cross-sectional view showing a terminal welding step in the manufacturing process of the secondary battery according to FIG. 1.

Referring to FIG. 4, during the manufacturing process of the secondary battery 10, the current collection plate 300, 400 may be welded to the electrode assembly 200. Then, the current collection plate 530, 630 may be welded to the current collection plate 300, 400. Separately, the insulator 520, 620 may be integrally provided with the cap plate 510, 610. In addition, the sub-terminal 540, 640 and the terminal plate 550, 650 may be coupled to the insulator 520, 620 (Alternatively, the sub-terminal and terminal may also be double-injected with the insulator, like the cap plate).

Thereafter, the terminal post 542, 642 and the current collection plate 530, 630 are aligned for welding. Here, the cap plate 510, 610 is inserted into the case 100 toward the upper arrow shown in FIG. 4. Due to an assembly tolerance or manufacturing process, movements may occur in the electrode assembly 200. Accordingly, the current collection plate 530, 630 may move left and right or up and down, as indicated by the lower arrow shown in FIG. 4. If the diameters of the terminal post 542, 642 and the diameter of the flat groove 532, 632 of the current collection plate 530, 630 are the same, the alignment for welding may be disturbed. However, according to some embodiments, the diameter (size) of the flat groove 532, 632 is larger than the diameter of the terminal post 542, 642. Therefore, even if the center of the current collection plate 530, 630 and the center of the terminal post 542, 642 are misaligned, the terminal post 542, 642 can always be welded on the flat groove 532, 632, as shown in FIG. 5. In addition, according to some embodiments, the terminal post 542, 642 may protrude toward the current collection plate 530, 630 more than the inner surface of the cap plate 510, 610, and the thickness of the current collection plate 530, 630 is greater than the thickness of the second coupling portion 524, 624 of the insulator 520, 620. Therefore, when the cap plate 510, 610 is coupled to the case 100, the terminal post 542, 642 is coupled while pressing the current collection plate 530, 630. Therefore, even if the current collection plate 530, 630 is not parallel to the cap plate 510, 610, the terminal post 542, 642 can always be welded on the flat groove 532, 632. That is, by the structures of the terminal post 542, 642 and the flat groove 532, 632, the adhesion between each of the current collection plate 530, 630, the sub-terminal 540, 640, and the terminal plate 550, 650 can be relatively improved.

According to the above-described embodiments of the present disclosure, the coupling between a terminal portion and a current collection plate can be relatively improved and the adhesion of a welding portion can be relatively improved. Accordingly, the bonding strength between a terminal and a current collection plate can be relatively improved, welding defects can be relatively reduced, and product reliability and mass manufacturability can be relatively improved.

While the foregoing embodiments have been described to practice the present disclosure, it should be understood that the embodiments described herein should be considered in a descriptive sense only and not for purposes of limitation, and various changes in form and details may be made therein without departing from the spirit and scope of the disclosure as defined by the following claims and their equivalents.

What is claimed is:

1. A secondary battery comprising:
a prismatic case having at least one end open;
an electrode assembly accommodated in the case;
a pair of current collection plates at both ends of the electrode assembly in a longitudinal direction and electrically connected to the electrode assembly; and
a pair of cap assemblies each coupled to both open ends of the case and having terminal portions electrically connected to the current collection plate,
wherein each of the terminal portions may include a terminal post that protrudes toward the current collection plate and is electrically connected to the current collection plate.

2. The secondary battery as claimed in claim 1, wherein the cap assembly comprises a cap plate coupled to the case, an insulator made of an insulating material outside the cap plate, and the terminal portions.

3. The secondary battery as claimed in claim 2, wherein a terminal portion of the terminal portions comprises a current collection plate of the current collection plates between the cap plate and the current collection plate, a sub-terminal outside the insulator and electrically connected to the current collection plate, and a terminal plate outside the sub-terminal and electrically connected to the sub-terminal.

4. The secondary battery as claimed in claim 3, wherein the sub-terminal and the terminal plate are separately provided.

5. The secondary battery as claimed in claim 3, wherein the sub-terminal and the terminal plate are integrally provided.

6. The secondary battery as claimed in claim 4, wherein the terminal post may be in the sub-terminal.

7. The secondary battery as claimed in claim 6, wherein a hole into which the terminal post is inserted penetrates in the cap plate and the insulator.

8. The secondary battery as claimed in claim 7, wherein in the current collection plate, a plate surface facing the cap plate is a flat surface.

9. The secondary battery as claimed in claim 8, wherein the current collection plate comprises a flat groove concavely provided on the plate surface facing the cap plate.

10. The secondary battery as claimed in claim 9, wherein the flat groove is circular or polygonal.

11. The secondary battery as claimed in claim 10, wherein the terminal post has a circular or polygonal cross-section and is shaped of a hollow cylinder.

12. The secondary battery as claimed in claim 11, wherein a diameter of the flat groove is larger than a diameter of the terminal post.

13. The secondary battery as claimed in claim 12, wherein a diameter of the hole in the cap plate and the insulator is larger than a diameter of the terminal post.

14. The secondary battery as claimed in claim 11, wherein a welding hole communicating with the terminal post is provided to penetrate.

15. The secondary battery as claimed in claim 2, further comprising a pair of current collection plates between the electrode assembly and the current collection plate and electrically connected to the electrode assembly and the current collection plate.

16. The secondary battery as claimed in claim 15, wherein a current collection plate of the current collection plates comprises a first plate surface protruding toward the cap plate, a connecting surface extending from both ends of the first plate surface, and a second plate surface extending from the connecting surface and welded to an electrode substrate tab of the electrode assembly.

17. The secondary battery as claimed in claim 16, wherein the insulator comprises a first coupling portion outside the cap plate and a second coupling portion inside the cap plate toward the current collection plate.

18. The secondary battery as claimed in claim 17, wherein a groove in which a sub-terminal and the terminal are seated is concavely provided in the first coupling portion, and a groove in which the current collection plate is seated is concavely provided in the second coupling portion.

19. The secondary battery as claimed in claim 18, wherein a height of the groove in the second coupling portion is smaller than a height of the current collection plate.

20. The secondary battery as claimed in claim 18, wherein a height of the groove in the first coupling portion is smaller than a sum of heights of the sub-terminal and a terminal plate.

21. The secondary battery as claimed in claim 20, wherein the terminal plate is a rectangular plate, which has a step between an outer surface and the surface facing the sub-terminal.

22. The secondary battery as claimed in claim 21, wherein the terminal plate has a flange having an edge of the surface facing a sub-terminal protruding outward.

23. The secondary battery as claimed in claim 22, wherein in the terminal plate, a size of the surface facing the sub-terminal corresponds to a size of the sub-terminal.

24. The secondary battery as claimed in claim 23, wherein the insulator further comprises an insertion groove provided concavely inside the groove of the first coupling portion, so that the flange of the terminal plate and the sub-terminal are inserted.

25. The secondary battery as claimed in claim 24, wherein the terminal post and the current collection plate are welded to each other through a welding hole of the terminal post.
